(19) United States
(12) Patent Application Publication
(10) Pub. No.: US 2013/0254343 A1
(43) Pub. Date: Sep. 26, 2013

(54) SERVER WITH MESSAGE EXCHANGE ACCOUNTING

(71) Applicants: Matthew J. Stevens, Lexington, MA (US); Ameya P. Shendarkar, San Mateo, CA (US)

(72) Inventors: Matthew J. Stevens, Lexington, MA (US); Ameya P. Shendarkar, San Mateo, CA (US)

(73) Assignee: AKAMAI TECHNOLOGIES INC., Cambridge, MA (US)

(21) Appl. No.: 13/471,079

(22) Filed: May 14, 2012

Related U.S. Application Data
(60) Provisional application No. 61/614,317, filed on Mar. 22, 2012.
(60) Provisional application No. 61/614,314, filed on Mar. 22, 2012.

(51) Int. Cl. G06F 15/16

(52) U.S. Cl. 709/219

(57) ABSTRACT

A server has a firewall module that performs accounting of traffic seen at the server. The traffic includes message exchanges, such as HTTP requests and HTTP responses. The server tests the message exchanges to determine if they match any of several message exchange categories. The server keeps statistics on matching traffic, for example the rate of matching traffic generated by a particular requesting client. Typically, the server is a proxy server that is part of a content delivery network (CDN), and the message exchanges occur between a client requesting content, the proxy server, other servers in the CDN, and/or an origin server from which the proxy server retrieves requested content. Using the message exchange model and the statistics generated thereby, the server can flag particular traffic or clients, and take protective action (e.g., deny, alert). In an alternate embodiment, a central control system gathers statistics from multiple servers for analysis.

### REFERENCE TO RELATED APPLICATIONS

This application claims the benefit of priority of U.S. Provisional Application No. 61/614,317, filed Mar. 22, 2012, and of U.S. Provisional Application No. 61/614,314, filed Mar. 22, 2012. The contents of those applications are hereby incorporated by reference in their entirety.

This patent document contains material which is subject to copyright protection. The copyright owner has no objection to the facsimile reproduction by anyone of the patent document or the patent disclosure, as it appears in Patent and Trademark Office patent files or records, but otherwise reserves all copyright rights.

### BACKGROUND OF THE INVENTION

1. Technical Field

This application relates generally to distributed data processing systems and to the analysis and accounting of network traffic.

2. Brief Description of the Related Art

Distributed computer systems are known in the prior art. One such distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. Typically, “content delivery” refers to the storage, caching, or transmission of content—such as web pages, streaming media and applications—on behalf of content providers, and ancillary technologies used therewith including, without limitation, DNS query handling, provisioning, data monitoring and reporting, content targeting, personalization, and business intelligence.

In a known system such as that shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML, embedded page objects, streaming media, software downloads, and the like) to the distributed computer system 100 and, in particular, to the servers (which are sometimes referred to as “edge” servers in light of the fact they may be located near an “edge” of the Internet). Such servers may be grouped together into a point of presence (POP) 107.

Typically, content providers offload their content delivery by aliasing (e.g., by a DNS CNAME) given content provider domains or sub-domains to domains that are managed by the service provider's authoritative domain name service. End user client machines 122 that desire such content may be directed to the servers in the distributed computer system to obtain that content more reliably and efficiently. For example, the CDN servers typically provide a proxy cache function, responding to the client requests by obtaining requested content from a local cache, from another CDN server (cache hierarchy), from the origin server 106 via a forward request, or from another source.

Although not shown in detail in FIG. 1, the distributed computer system may also include other infrastructure, such as a distributed data collection system 108 that collects usage and other data from the servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the CDN servers.

As illustrated in FIG. 2, a given machine 200 in the CDN (sometimes referred to as an “edge machine”) comprises commodity hardware (e.g., an Intel Pentium processor) 202 running an operating system kernel (such as Linux or variant) 204 that supports one or more applications 206a-n. To facilitate content delivery services, for example, given machines typically run a set of applications, such as an HTTP proxy 207, a name server 208, a local monitoring process 210, a distributed data collection process 212, and the like. The HTTP proxy 207 (sometimes referred to herein as a global host or “ghost”) typically includes a manager process for managing a cache and delivery of content from the machine. For streaming media, the machine might include one or more media servers, such as a Windows Media Server (WMS) or Flash 2.0 server, as required by the supported media formats.

The machine shown in FIG. 2 may be configured to provide one or more extended content delivery features, preferably on a domain-specific, customer-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,111,057 illustrates a useful infrastructure for delivering and managing server content control information and this and other server control information (sometimes referred to as “metadata”) can be provisioned by the CDN service provider itself, or (via an extranet or the like) the content provider customer who operates the origin server.

The CDN may include a network storage subsystem (sometimes referred to as “NetStorage”) which may be located in a network datacenter accessible to the CDN servers, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference. For example, the CDN may provide a tiered distribution service by having a set of CDN servers organized into regions and that provide content delivery on behalf of participating content providers. A cache hierarchy is established in the CDN comprising a given CDN server region and either (a) a single parent region, or (b) a subset of the CDN server regions. In response to a determination that a given object request cannot be serviced in the given CDN region, instead of contacting the origin server, the request is provided to either the single parent region or to a given one of the subset of CDN server regions for handling, preferably as a function of metadata associated with the given object request. The given object request is then serviced, if possible, by a given CDN server in either the single parent region or the given subset region. The original request is typically only forwarded on to the origin server if the request cannot be serviced by an intermediate node.

For live streaming delivery, the CDN may include a live delivery subsystem, such as described in U.S. Pat. No. 7,296,082, and U.S. Publication No. 2011/0173345, the disclosures of which are incorporated herein by reference.

The CDN may also provide a distributed firewall system for its customers, leveraging the CDN server infrastructure to analyze and block traffic from suspicious or harmful clients at the edge. A firewall system and service is described in U.S. Patent Application No. 2011/0225647, the contents of which are hereby incorporated by reference. As described there, in certain embodiments the system operates by having CDN servers apply match rules to incoming client requests and takes certain actions (such as denying the request or generating an alert) upon detection of security threats or attacks.

While such systems are very useful and valuable, there is a need for more information about the traffic hitting a particular website. Such information is useful not only for detecting and countering attacks (e.g., using a firewall mechanism as described above), but also in analyzing and addressing other uses of the site, such as undesirable bot activity (e.g., undesirable data scraping). In addition, such information can be used to gain a view of end-user behavior on a site.

The teachings herein address these and other needs that will become apparent in view of this disclosure.

### SUMMARY

According to certain embodiments disclosed in more detail below, the functionality of a CDN server is extended with a rate accounting module that categorizes traffic between a client and the server and/or between the server and another server (e.g., an origin server), performs accounting on traffic falling within those categories over a period of time, uses configurable threshold criteria to identify excessive or otherwise problematic traffic during the period, and applies an enforcement policy against such identified traffic. Typically, the identified traffic, sometimes referred to herein as “qualified” traffic”, represents an excessive rate of requests from a particular client. In that case, a policy-defined action may be taken against that particular client, as represented by a client identifier such as a particular client IP address, session id, or otherwise. However, in other cases, the system may identify excessive traffic for a particular universal resource identifier (URI), for example. Indeed, traffic statistics may be kept by client identifier, by URI, or with respect to any of a variety of other keys, as will become clear from the discussion below.

The rate accounting systems and methods described herein extend the capabilities of a cloud-based firewall module, such as that described in U.S. Patent Application No. 2011/0225647, the contents of which are hereby incorporated by reference.

The traffic categorization function preferably leverages a semantic message-exchange model that enables categorization based one or more aspects of an exchange of messages that are touching the CDN server. For example, a message exchange may involve messages that flow between a client and the CDN server, and/or between a client and the CDN server and the CDN server and an origin server (i.e., as the CDN server retrieves the content requested by the client from the origin server via a forward request). A message exchange may also include messages that flow between two CDN servers as they seek to satisfy a client request (e.g., as in a cache hierarchy solution).

Virtually any aspect of a message exchange may be used to drive categorization. For example, traffic categorization may be based on the content of an initial client request to the CDN server. In this case, the server examines information in the client request such as the client IP address, a session identifier, user-agent header, whether the request includes an HTTP method such as GET or POST, etc., the resource (URI) requested or type of resource requested, the use of particular URI parameters, usernames, other HTTP header or body information, and so on.

Traffic categorization may also be based other events within a message exchange, such as what internal/intermediate actions the CDN server must perform in response to the client request. For example, does the request cause the CDN server to look for content in a local cache, to make a forward request to an origin server for content (cache miss), or is the requested content non-cacheable content, etc. Likewise, the categorization may be based on the content of the response from the origin server (e.g., an HTTP 4xx or 5xx status code, or other error message returned from origin server) or from a parent CDN server.

Composite criteria may be used to drive categorization off of one of the above aspects of the message exchange.

Preferably, the definition of a particular category is configurable. Configurability enables each content provider customer of a CDN to define the kind of traffic on their website for which the server should keep statistics (categorization policy), and then define what the CDN server should do when excessive amounts of that traffic is seen in a given category (enforcement policy).

In an implementation utilizing centralized threat assessment and defense, the CDN servers can report information about the categorized message exchanges and/or the “qualified” clients they are encountering to a central data collection and control system. The central system analyzes the data from multiple CDN servers to determine what defensive postures should be undertaken by the network. The central system may then instruct the CDN servers—including in particular servers that have not encountered any excessive traffic—as to a policy to apply proactively against the identified threats.

As those skilled in the art will recognize, the foregoing description merely refers to examples of the invention and is not limiting. Moreover, the teachings hereof may be realized in a variety of systems, methods, apparatus, and non-transitory computer-readable media. It should also be noted that the allocation of functions to different machines is not limiting, as the functions recited herein may be combined or split amongst different machines in a variety of ways.

It is also noted that while the teachings hereof apply to CDNs, implementation within a CDN is not necessary to take advantage of these teachings. Thus, any server (not part of a CDN) may be modified to perform rate accounting based on message exchange categorization of requests and responses that the server is encountering.

By way of further example, in one embodiment of the invention, a server participates in an exchange of messages flowing between that server and a client, and/or between that server and an origin server. The exchange of messages is in accordance with a protocol, such as HTTP, which provides for certain kinds of request messages and certain kinds of response messages. The server applies match conditions to messages in the message exchange, for example testing the content of a client request, or of a response from the origin, or of a message to be sent or received from the server itself to one of those other devices. The match conditions define a category of traffic that may occur at the server and is of interest. If and when the match conditions are satisfied, the server will log information about the message exchange. Typically this involves incrementing a count to reflect that a matching message has been encountered. The count may be kept on a per client-id, per URI, or other basis, as noted above. If the match conditions are not satisfied, the server does not increment the count. The count can be used to calculate rates of particular traffic, and then compared to configurable thresholds to determine if it is excessive. If so, the server can take steps to limit that traffic, i.e. by denying at least some of it, or generate alerts or apply some other enforcement policy.

Match conditions often require the server to examine multiple messages, including both requests and responses flowing amongst the client/servers, to determinate if the overall message exchange falls within the category defined by the match conditions. For example, the match conditions may specify some URI to match against the request, but also require that the server make a forward request to the origin to satisfy that request (i.e., a match condition that is satisfied by any request message from the server to the origin server.)

The match conditions may specify matching value(s) for a message header or message body. With HTTP, the match condition may specify the HTTP method that the client is using.

In another embodiment of the invention, a server participates in an exchange of messages between the server and a client, and/or the server and another server (i.e., origin server), as described above. Upon receipt of a request/response message in the message exchange, the server reads from a metadata control file (such as an XML file) that directs the operation of the server in reaction to the received message. Typically, the control file is one of many that are each associated with a particular content provider or content provider domain for which the server is handling traffic. The server determines whether the receive message meets one or more conditions specified in the control file, the one or more conditions effectively defining a category of traffic occurring at the server (either being received or being sent) and that is of interest. Some conditions may match against the content of a request, others the content of a response, etc., necessitating the examination of multiple messages to determine if the traffic meets the defined category. Hence, the server repeatedly applies these control file-specified conditions for multiple received request/response messages. If a category is matched, then the server records information, typically by incrementing a count as previously explained.

In another embodiment of the invention, a system includes a plurality of servers in a content delivery network (CDN). A least one of the servers (i) receives requests from clients for content associated with a given content provider, and (ii) determines that the content of each of a plurality of requests matches one or more criteria defining a category, and if so, records information (e.g., incrementing a count). The one or more criteria are preferably configurable on a content provider by content provider basis, and a given content provider can be associated with multiple categories. The server further (iii) determines a rate of requests matching the category for each of a plurality of clients that are making the requests, and (iv) compares the rate of requests to a threshold value that is configurable on a content provider by content provider basis, and (v) applies an enforcement policy against clients that exceed the threshold, the enforcement policy being configurable on a content provider by content provider basis.

The enforcement policy may include a set of potential actions such as denying requests or generating alerts about requests, etc., or may specify a logical rule to be applied to subsequent requests from the client which must be satisfied before taking action against the client. Once a determination is made to apply the enforcement policy against a given client, the server may apply the enforcement policy against that given client for a predetermined period of time (a penalty period), regardless of the rate of requests from that given client during the period.

In yet another embodiment of the invention, a distributed computing system such as a CDN includes a plurality of content servers (typically proxy servers) and one or more control servers, the plurality of content servers and the one or more control servers being communicatively coupled to one another via a global computer network. Each of the plurality of content servers participates in an exchange of messages between at least one of (i) a client and the content server and (ii) the content server and another server, and applies match conditions against the content of multiple messages in the exchange of messages, as previously explained. The content servers record information about the message exchange (incrementing a count, for example) if the match conditions are satisfied. Each content server may determine from the recorded information that an enforcement policy should be applied against the client or a URI related to the exchange of messages. The content server sends the recorded information and/or and/or the determination about the enforcement policy to the one or more control servers. Typically the enforcement policy is triggered when an excessive rate of messages is found from a particular client or for a particular URI, etc., as previously explained.

The control servers receive the data from the individual content servers and analyze it to determine whether to send instructions to content servers (including servers other than the one that sent the original information) that will configure them to apply an enforcement policy against the client or the URI. Hence, the detected threats at one server may be countered at other servers in the system. Alternatively, threats detected at one server may be analyzed by the control servers and used to instruct that same server to change its enforcement policy (e.g., upgrading it).

### BRIEF DESCRIPTION OF THE DRAWINGS

The invention will be more fully understood from the following detailed description taken in conjunction with the accompanying drawings, in which:

FIG. 1 is a schematic diagram illustrating one embodiment of a known distributed computer system configured as a content delivery network (CDN);

FIG. 2 is a schematic diagram illustrating one embodiment of a machine on which a CDN server in the system of FIG. 1 can be implemented;

FIG. 3 is a diagram illustrating one embodiment of a distributed, cloud-based firewall system;

FIG. 4 is a diagram illustrating message exchanges in various contexts;

FIG. 5 is a diagram illustrating one embodiment of an architecture for classifying traffic and performing rate accounting on traffic at a CDN server;

FIG. 6 is a chart illustrating traffic (in this example, client requests) received during sampling periods from a particular client IP address and that cause the client IP address to be subject to penalty periods;

FIG. 7 is a flow diagram illustrating an example of a rate accounting workflow in a CDN server;

FIG. 8 is a schematic diagram illustrating an example of a summary qualification table;

FIG. 9 is a diagram illustrating a portal user interface for specifying a message exchange category;

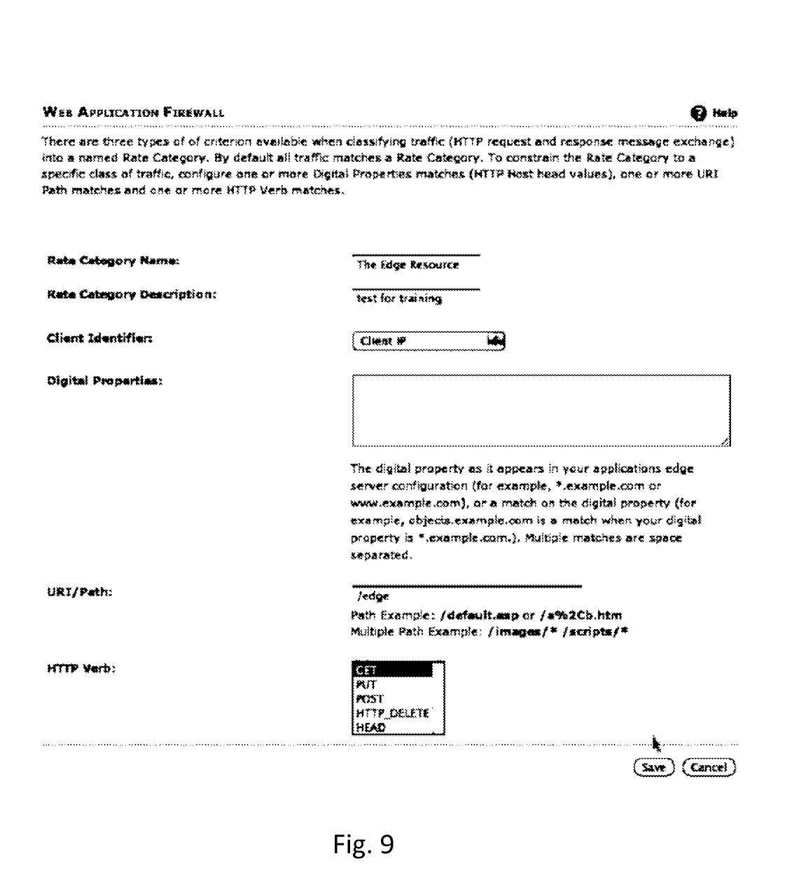

FIG. 10 is a diagram illustrating a user interface for specifying, on a message exchange category basis, enforcement rules to be applied against qualified clients;

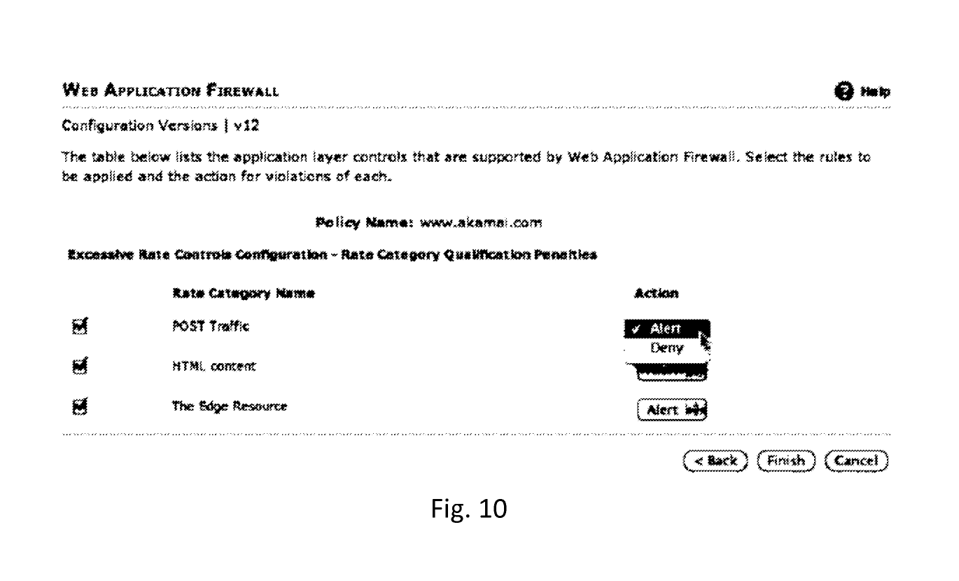

FIG. 11 is an example of control file metadata defining some of the message exchange categories shown in FIG. 10, which metadata may be authored explicitly or generated automatically from the portal following the user's definition of the category (as shown in FIG. 9); and,

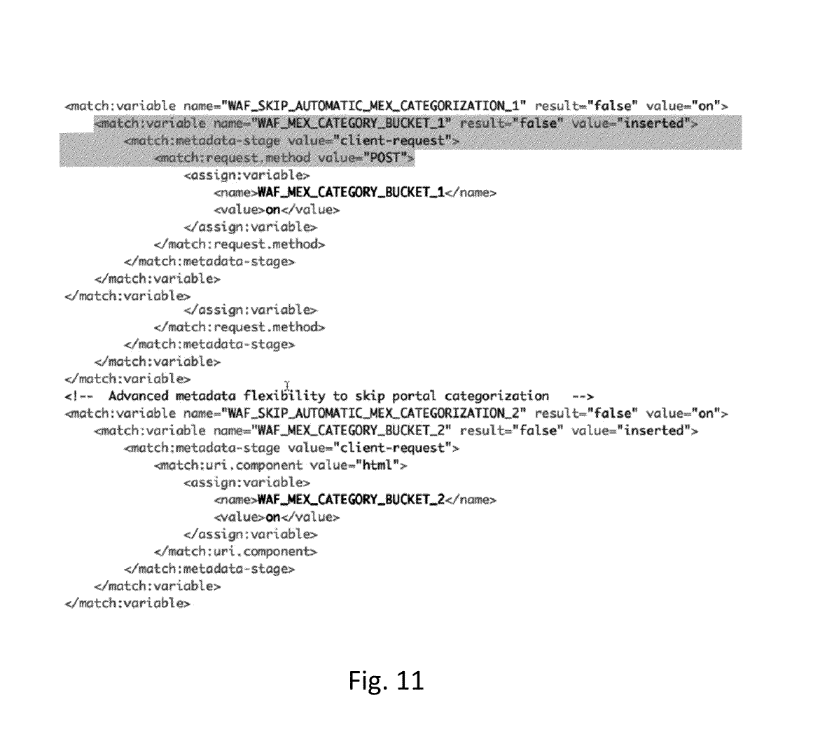

FIG. 12 is a block diagram illustrating hardware in a computer system used to implement the teachings hereof.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the scope of the invention is defined solely by the claims. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety.

Cloud-Based Firewall

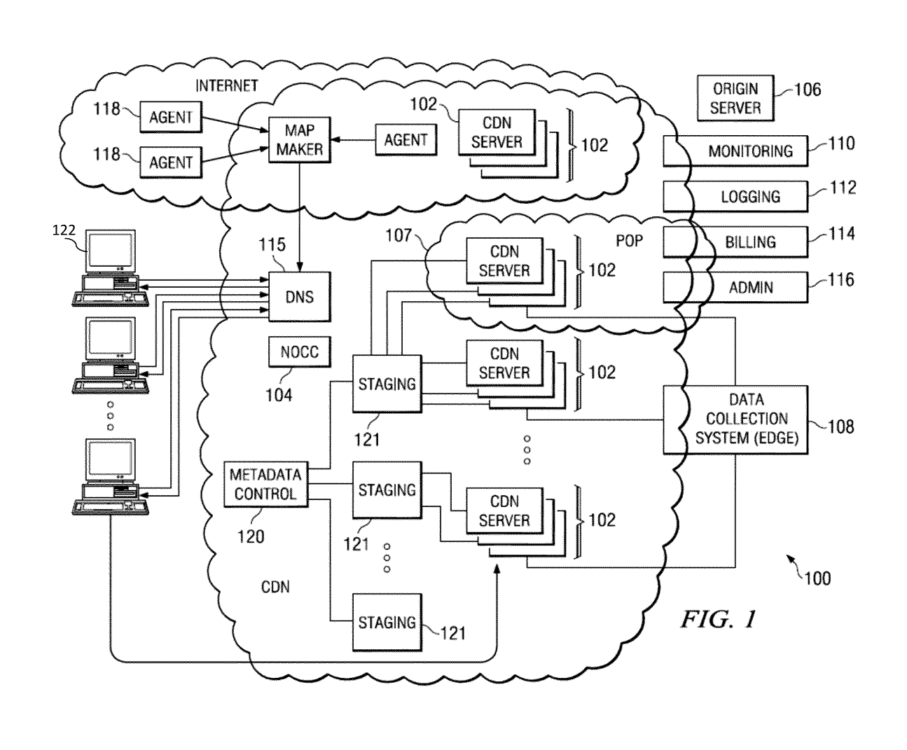

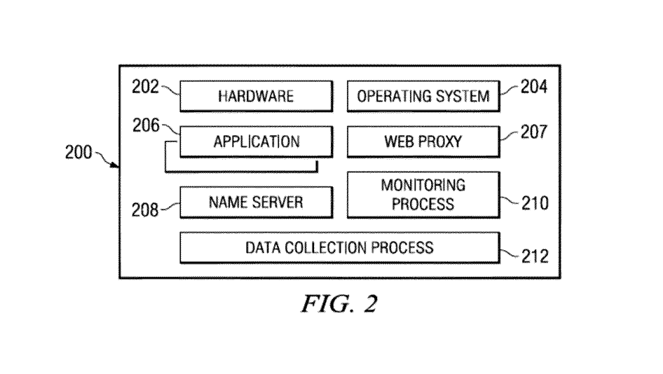

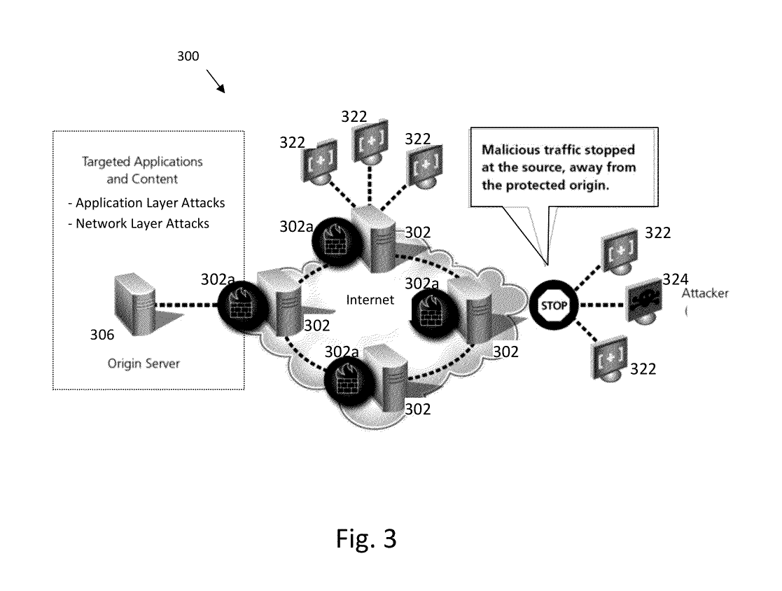

FIG. 3 illustrates a distributed, cloud-based firewall system 300 and service described in U.S. Patent Application No. 2011/0225647, the contents of which are hereby incorporated by reference. CDN servers 302 are distributed around the Internet as part of a CDN, as previously discussed above in connection with FIGS. 1-2. In system 300, each CDN server 302 includes and/or is coupled to a firewall 302a. The firewalls 302a inspect and filter traffic, and are configured to block or pass traffic based on specified security criteria.

Client machines 322 desiring content from the origin server 306 make requests (typically an HTTP or HTTPS request) to one of the CDN servers 302. The requests are examined at the network edge by the firewalls 302a, which apply rulesets to the requests. Requests that pass the firewalls 302a are processed normally, often with the requested content being served from the CDN server's 302 cache, or being retrieved by the CDN server 302 from the origin server 306 for delivery to the client machine 322. Requests that are identified as attacks or other security threats (such as those from attacker machine 324) trigger the firewall 302a to take defensive action, e.g., blocking the request, logging it for alert, or otherwise. Hence, threats are identified and addressed by the system 300 closer to the source of the request, before reaching the origin server 306. This offloads the burden from the origin server 306.

Preferably, and as described in U.S. Patent Application No. 2011/0225647, the firewall system is based on a set of core rules (e.g., a rule set available from Breach Security Labs, e.g., ModSecurity v1.6). ModSecurity applies a broad set of match criteria to HTTP requests to identify behaviors that can be classified as attacks, leakage of information or other kinds of security threats. The Core Rule Set defines security rules as well as configuration parameters for the web server. On a high level, a security rule is an expression associated with data. The expression is usually the combination of an operator, variables and translations, which yields a Boolean. An expression can also be a logical OR or AND between other expressions, or the negation of another expression. The data for each rule consists of an identifier (or “id”), a tag, a message, a flag that tells if the request should be denied, a severity level, etc.

These core rules (or a subset thereof) are converted into a metadata functional solution, with control metadata being delivered to and applied at the CDN servers in the manner described in U.S. Pat. No. 7,240,100, the disclosure of which is incorporated herein by reference. In particular, preferably the metadata is provisioned via a customer-facing extranet portal (e.g., a Web-based interface) and provided to the CDN servers within a metadata configuration file. Because the configuration file may need to change frequently (to deal with attack scenarios), preferably the firewall-related metadata configuration is delivered to CDN server processes using a dedicated and fast communication channel. See, U.S. Pat. No. 7,149,807 (the disclosure of which is incorporated herein by reference) for a useful communication infrastructure that may be used for this purpose. Preferably, the deployment of the configuration files throughout the distributed system can be accomplished within a short period of time, advantageously enabling real-time response to attacks.

Although the CDN service provider can configure the firewalls 302a directly, the system 300 also allows the content providers associated with the origin server 306, as customers of the CDN, to configure the firewall settings that will apply to requests that content provider's content. This is accomplished using the metadata approach described above. Hence, the CDN infrastructure is shared across multiple CDN customers, but each customer can provision and manage its own firewall to protect against attacks.

Rate Accounting

In accordance with this disclosure, a CDN server firewall as described above can be extended to perform ‘rate of traffic’ accounting and (if desired) defend against an excessive rate of requests at the edge, thus enhancing the protection afforded to the origin server and to the CDN itself. A typical scenario might involve an ‘excessive’ rate of requests that are coming from a particular client, i.e., a client that is sending more than X messages to a CDN server in Y time period. Such a client may be blocked for Z period of time by the CDN server, among other potential defensive actions.

As will be seen below, however, the approach described herein is neither limited to the rate accounting of requests, nor to rate accounting on the basis of who (which client) is sending the requests.

The exemplary system described here supports rate accounting within a CDN server and “excessive” rate qualification criteria modeled as message exchange categories. This design supports stateful, rate-based categorization of the message exchange principal inline to the CDN server (i.e., intra-server). Over time, the CDN server will account for the rates of the per-content provider (or per domain), categorized traffic. Over the steady-state, security policy rules may trigger defensive postures based on discrete matches individual requests have on the traffic categories. Rates may be accounted for using a variety of identity models. For example, in one embodiment, rates may be tabulated by requesting clients, e.g., by client IP address or other such client identifier. In other embodiments, identifiers relating to the principal actor (which may or may not uniquely correspond to the particular device with which the server is interacting) may be used, such as session ids or cookies, user id, SAML id or attribute, tokens, or other values extracted from a message header or body. Also supported are models not based on client identity. For example, rate accounting may occur based on the number of message exchanges relating to a particular resource identifier (URI) or resource type.

The exemplary system described herein supports isolation of domain traffic into message exchange categories, performance of rate accounting on categories, application of qualification criteria to identify “excessive” rates, and then tracking of these qualifications for use in security policy rules and triggered defensive postures.

The system may be configured and categories and enforcement policies may be defined via a metadata configuration file, as described above in connection with FIG. 2. Hence, the system is configurable on content provider by content provider basis, or a domain by domain basis.

Message Exchange

In this section the concepts of the message exchange and message exchange categorization are discussed. The message exchange (or “mex”) refers to the coordinated exchange (or bracket) of protocol messages for a particular exchange pattern. In a typical case, HTTP, there is a “request/response” message exchange pattern. The HTTP message exchange thus refers to this bracket of an HTTP request message and HTTP response message. There is a correlation to existing terminology used commonly in products in trans-GRESS-ion terms: egress, ingress, midgress. For example, “egress” refers to the mex at the edge of the system with an end-user client (i.e., the between the client and a CDN server). “Ingress” refers to the mex with the forward origin server—in this case the CDN server is in the role of a “client” and the origin is the “server.” “Midgress” refers the inter-region intermediate message exchanges in the CDN platform, e.g., a request for content from a CDN server to a parent region CDN server using a cache hierarchy approach. The examination of and accounting for client requests is an egress portion of the message exchange. As noted previously, however, the midgress and egress portions of the message exchange are also examined and used for accounting purposes.

Because of the layered nature of the CDN solutions like that shown in FIG. 1 (many message exchanges with actors in the role of both client and server at different stages), we can use the term message exchange “principal” to refer to the identified actor of the end-user client. For example, a person sitting with their browser, perhaps coming over varying network infrastructure is the “principal”. Similarly, the entity in control of a bot is principal too, whether it is a “good” bot like web services consumer or a “bad” bot like an attacker or scraper.

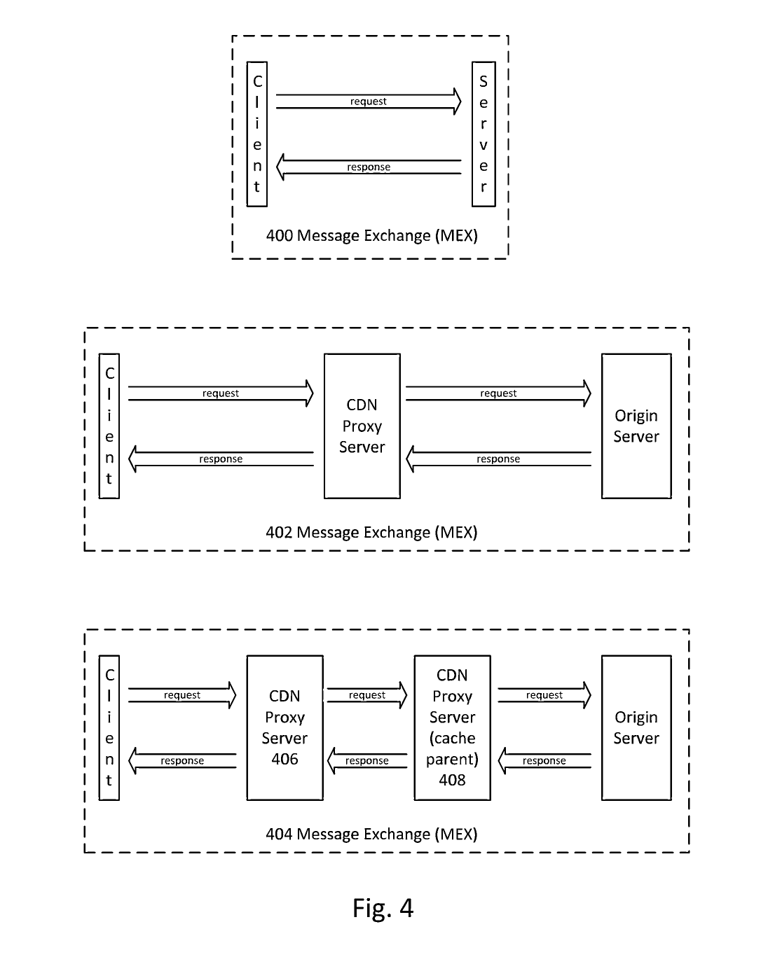

FIG. 4 provides three illustrations of the message exchange concept. Block 400 illustrates several request/response events that may occur between a client and a server.

Block 402 illustrates a message exchange within the context of the CDN described with respect to FIG. 1. In block 402, for example, the CDN server receives a client request, such as an HTTP GET or POST or other HTTP verb. To respond to the request, the CDN server might check local cache for the content. If the content not available in cache, the CDN server (acting now as a client) makes a forward request to the content from an origin server, and receives a response from the origin server. The CDN server then sends the response, be it from local cache or origin server, to the client. Block 402 may be thought of as having two message exchanges (one on each side of the CDN server) that is part of a larger message exchange reflecting the entire transaction chain. In other embodiments, it should be noted, forward request may be made to a network storage solution rather than an origin server.

Block 404 illustrates a message exchange that involves a ‘midgress’ portion, between two CDN servers. The first CDN server 406 initially looks to the cache parent CDN server 408 for the requested content. The fact that the first CDN server 406 makes this request to the cache parent CDN server 408 may be a trigger for message exchange classification and accounting. If the parent CDN server 408 does not have the content, then either the first CDN server 406 or the parent CDN server 408 can request the content from origin 410, depending on the implementation. In the implementation shown in FIG. 4 the parent CDN server 408 makes the request to origin server, but this is merely one example.

Architecture Overview

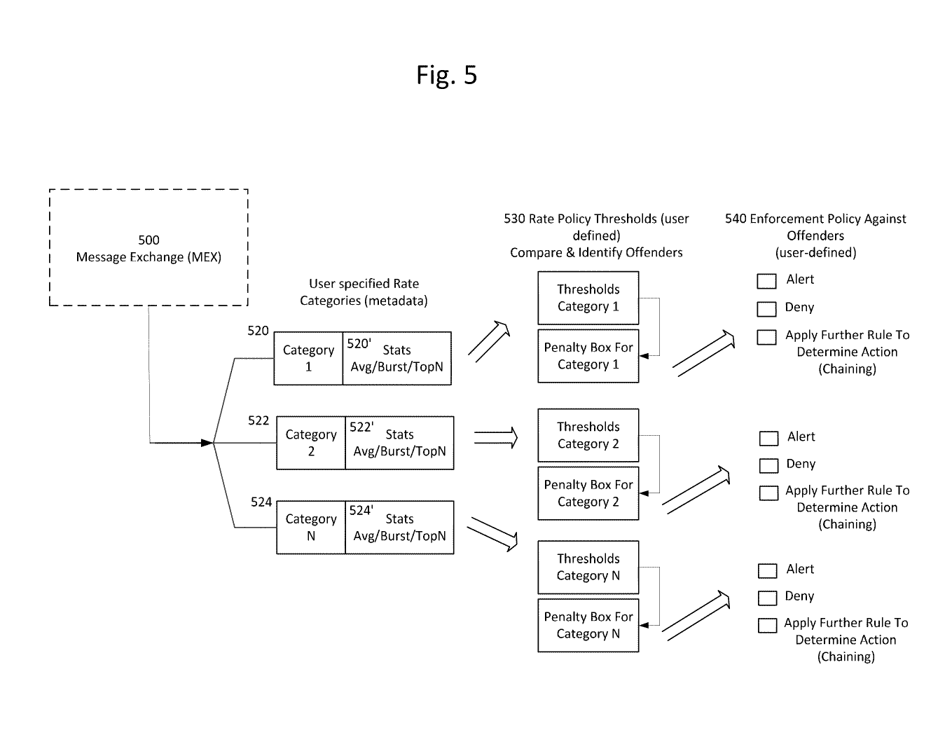

FIG. 5 provides a schematic overview of one embodiment of rate-accounting system operating in a given CDN server. The system may operate likewise in a non-CDN server, as noted previously.

Referring to FIG. 5, various message exchange categories are shown in blocks 520, 522, 524. The categories are defined by metadata matching rules and hence are completely configurable. In this implementation, the categories 520, 522, 524 represent categories of message exchanges that are being tracked by the CDN server for rate accounting purposes. Thus the categories represent the nature of traffic that is to be accounted for in rate accounting tables 520′, 522′ and 524′, and the categories can be thought of as ‘rate categories’.

A given message exchange category may be triggered based on any aspect (or multiple aspects) of the message exchange, be it a request or response event, or some content in the request or response, or otherwise. For example, category 522 might match against all HTTP get requests, or against HTTP requests for a particular set of resources. Category 524 might capture HTTP get requests that result in a forward request to the origin. Another category might capture HTTP requests that result in a particular status code response from the origin server (such as status code 500—server error, or status code 404—resource not found). Another category might capture get requests that result in a forward request to another CDN server.

Note that the categories need not be mutually exclusive—a given message exchange may fall within multiple categories. The CDN server would then update multiple rate tables. Note also that any number of rules—such as rulesets described in U.S. Patent Publication No. 2011/0225647 that describe known threats based on the content of client request messages—may be chained together with Boolean logic to define message exchange categories.

The rate accounting tables 520′, 522′ and 524′ (sometimes referred to as inline rate accounting tables or IRAs) in FIG. 5 store the raw data used to calculate rates of interest. Below is an example of the table structure, where the total hits, entry time, burst hits, and burst window ID are repeated for each category.

In the example that follows, client identifier (client ID) is represented by client IP address, and the table below therefore accounts for message exchange rates by client IP address. As mentioned previously, in alternate embodiments the rate accounting table may use other identifiers as a key. For example, the identifier might be a session id, token, cookie, SAML assertion, user-agent or user-agent derived device-characteristic, or other value extracted from the header or body of a message. Furthermore, as also described above, rate accounting is not limited to a client identity model. In alternate embodiments, the rate accounting table may tabulate message exchange rates by URI, or by resource type. Indeed, a rate accounting table may account for activity using an identifier that relates to any layer in the network stack (the network layer, transport layer, and application layer being of particular relevance). The use of client IP address is not limiting and used below merely as an illustration of the concept.

TABLE 1

| | Rate Category N | | | | Rate Category M | | | |
|---|---|---|---|---|---|---|---|---|
| Client ID (IP | | Entry | Burst | Burst | | Entry | Burst | Burst |
| address) | Total Hits | Time | Hits | Window_id | Total Hits | Time | Hits | Window_id |

1.1.1.1
2.2.2.2
3.3.3.3

For ease of illustration, assume that the message exchange category of interest captures all client requests. As client requests are received by the CDN server, the rate accounting functions apply qualification algorithms (below) to the traffic based on a sampling period.
Average—This is a mathematical average of the total client requests received per client IP address divided by the elapsed time the client was recorded in the table during the sampling period. The formula=total hits/(sampling period−entry time). For example, if a sampling period were 360 seconds and a client request first matched a category definition 30 seconds into the sampling period and then sent 660 requests, the average would be =660/(360−30)=660/330=2 requests/second.
Burst—This is also a mathematical average of hits received in a N-second moving window (total hits during the burst window/N seconds). For each window within the sampling period, the server counts hits, and then averages the hits at the conclusion of the window. If the average exceeds the burst threshold, a flag is set. Then, the burst hit column is purged and counting commences from 1.
Top-N—The top N clients across the server for a particular content provider, or for a particular content provider domain.

The sampling period for a given CDN server is—at least in one implementation—asynchronous, meaning each CDN server in the CDN system has a different start and stop clock time for the sampling period. This results in the ability of network to detect attacks that are both (1) short-lived with durations less than the sampling period, as well as (2) attacks that exhibit fast bursts of less than the sampling period.

For the Average and Burst algorithms, the content provider customer can configure thresholds specifying the maximum rate acceptable for each. The combined definition of the rate category and thresholds represents a rate policy.

At the conclusion of the sampling period, the CDN server compares the total count for each client IP address in the table against the thresholds defined for each rate policy. Also, if during the sampling period the burst threshold was exceeded in a window, the burst flag is set.

At the conclusion of the sampling period, the CDN server applies rate policies 530 against the rate accounting tables 520′, 522′ 524′ to determine whether a particular client IP address should be qualified as an offender. The CDN server applies the policies by comparing the total count for each client IP address in the table against thresholds defined for each rate policy. Also, if during the sampling period the burst threshold was exceeded in a window, the burst flag is set. Client IPs that exceeded the thresholds under one or more algorithms are considered “qualified”. If qualified, the client IP address is placed in a qualification table—along with the rate, category, and algorithm that qualified it—for a period of time. The rate accounting table may then be purged and accounting commenced for the next sampling period.

A client IP address remains in the qualification table for a configurable period of time—a penalty period. The penalty period is generally several times longer than the sampling period. During this “penalty” period the rate accounting functions continue to measure the client's request rate during successive sampling periods. If a client IP address is re-qualified in subsequent sampling periods, the most current rate, category and burst algorithm qualified will be entered in the table with a fresh time-to-live value (i.e., the penalty period will restart). However, if the client IP address fails to re-qualify in subsequent sampling periods, the penalty period will expire. At the conclusion of the penalty period, the client IP address will be removed from the qualification table.

To summarize qualification: (1) a client IP address (representing the client identity in this example) will remain qualified if it continues to exceed one or more rate policy thresholds. (2) The rate entered in the qualification table will be the most recent sampling period in which qualification occurred. (3) When a client IP address ceases activities that caused it to qualify, it will remain in the qualification table for the penalty period (configurable). The qualification table function thus may be thought of as a “penalty box” where a client IP address remains for a configurable penalty period.

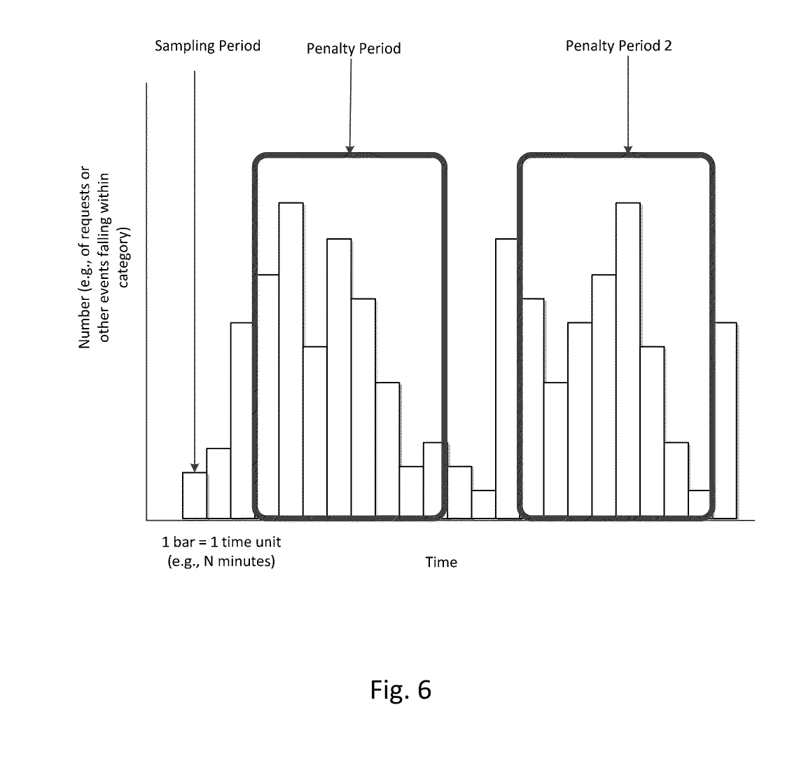

FIG. 6 illustrates the operation of the sampling period followed by a penalty period or penalty box. The traffic from a particular client is sampled (rate accounted) during the sampling period, the client is qualified and placed in the qualification table, and the traffic during the penalty period is blocked or subject to other enforcement policy action. Assuming the client ceases activity that caused it to qualify, it is removed from the penalty box, but violations in a subsequent sampling period result in re-qualification and penalty period 2.

Returning to FIG. 5, the system includes enforcement rules 540 (sometimes referred to as excessive rate control rules) that define enforcement policy against qualified clients, i.e., client IP addresses that are in the “penalty box.” Possible actions include generating an alert about the client (do not deny the request, only generate an alert and continue processing the request), or denying the client (deny requests from the client IP address, resulting in a HTTP 403 response, generation of an alert, and stop processing the request). Generating an alert may mean that information about the client is logged and shown in a portal display or in logs, that a real-time alert is sent, or that the edge server appends information about the alert in a forward request to the origin server, or otherwise. Other actions include responding to the qualified client but modifying CDN server behavior on the response, such as generating a custom warning page, or fulfilling requests for qualified clients only from cache and not making forward requests from origin.

Denying the client means that requests from that client IP address are denied at the edge, mitigating impact both on the CDN server itself and upstream at other CDN servers and/or the origin server. In some embodiments, an IP address white-list may be used to prevent certain clients from being denied or the subject of alerts (i.e., known “good” clients).

Note that the decision to take enforcement action against a qualified client IP address may be made contingent on an application of further rules about the content of the request (or other aspect of the message exchange). For example, an enforcement policy might specify generation of an alert against a request from a qualified client IP address, but deny the request if the request is from a qualified client IP address and is for a particular URI, or if the request is from a qualified client IP address and the load of the CDN server has passed a threshold (a quality of service factor).

It bears repeating that while the client IP address is one implementation and has been used above for illustrative purposes, in other embodiments the system may use other kinds of client identifiers. Alternative identifiers include a session id, cookie, etc., as noted above, or even non-client identifying data such as a requested URI. The qualification and enforcement process would then apply against such session id, user id, cookie, URI, and so on. For example, excessive requests from a “qualified” user-id, or to a “qualified” URI, would be blocked or otherwise subject to defensive action.

More generally, while the foregoing embodiment is based on message exchange “principal” “identification” (using client IP address), using a rate filter and request blocking rules also keyed off of the peer client IP address, in other embodiments, one may employ different means of identification, different filters and composite rules. The categorization of message exchange traffic can be used for a wide variety of purposes, e.g., for other firewall functions and/or enforcement rules. For example, one might define a particular message exchange category that is to be blocked or treated in a particular way, regardless of the rate of the message exchange traffic. Such categories will often target some form of undesirable activity on the website, or identify the characteristics of an undesirable actor.

More on Message Exchange Categorization

This section describes an exemplary implementation of message exchange categorization function. Message exchange categorization may be accomplished using a metadata configuration file approach. During request/response processing, a CDN server applies a metadata control file as described in U.S. Pat. No. 7,240,100. The metadata is applied in lexical order during specialized stages of the HTTP request/response message exchange pattern. The CDN server may iterate through the metadata control file as it proceeds through different stages of the transaction, leading to categorization of the message exchange as different stages are passed through. Triggering match rules may affect the state of the message exchange, which in some cases lead to further changes in the meta-model (state changes) and further match rules to be evaluated (at later stages), ultimately leading to categorization of the message exchange. For example, assuming a metadata interface to state of triggered match rules, an alert triggered during client-request stage can drive criteria of policy lexically after or in a later stage. In practice, this approach allows a message exchange category to be dependent on multiple aspects or events that occur at different stages of the overall transaction, e.g., as part of the initial request, as part of a forward request, or as part of responses from the origin to CDN server or CDN server to client, or as part of various “edge-services” such as internet packet routing and request/response body inspection.

In operation, when the CDN server receives a request, it can check the appropriate mex categorization criteria against that request. If other criteria from a later stage (e.g., from the origin response) are required to meet the mex category, the CDN server will need to apply those criteria at the later stage. Hence, the CDN server keeps some state information indicating that at least some of the mex criteria have been met, either in memory as part of a thread or other processing construct, or by setting a control variable in metadata control file, or otherwise as known in the art. The CDN server proceeds with processing the request, and, to continue this example, makes a forward request to the origin server. When that response is received, the CDN server consults the state information and applies the appropriate criteria (iterating through the metadata control file again if necessary) to the origin response, and makes a final determination that the message exchange matches the given category.

Message exchange categories preferably have semantic meaning to a content provider. With the foregoing metadata approach, each content provider may configure categories of significance to them for rate accounting. For example, a category may represent traffic on a website's product catalog, or requests for dynamic web resources, traffic at security end-points, search systems, or inventory/pricing systems.

To create and configure message exchange categories, a web portal with a configuration manager for the cloud-based firewall solution is provided. Three rate categories are configured in the example scenario below: All, Catalog and Order. The values T, B, and S are variables.

### EXAMPLE 1

Category Name: “All”
Client Identification: default (client-ip supported) (not displayed)
DOMAIN: ALL
URIs: ALL
VERB: ALL
EDGE SERVER HIT: TRUE (sets request-type MATCH)
ORIGIN HIT: TRUE (sets request-type MATCH)
Sample Window: default T min
Excessive Burst Rate: B req/sec
Excessive Summary Rate: S req/sec
Automatic Penalty Box for Excessive Rates: default FALSE

### EXAMPLE 2

Category Name: “Catalog”
Client Identification: default (client-ip supported) (not displayed)
DOMAIN: www.customer.com
URIs: /productspages/*, /search/*
VERB: GET
EDGE SERVER HIT: TRUE (sets request-type MATCH)
ORIGIN HIT: TRUE (sets request-type MATCH)
Sample Window: default T min (not display)
Excessive Burst Rate: B req/sec
Excessive Summary Rate: S req/sec
Automatic Penalty Box for Excessive Rates: default FALSE

### EXAMPLE 3

Category Name: “BuyFlow”
Client Identification: default (client-ip supported) (not displayed)
DOMAIN: www.customer.com
URIs: /orders/*
VERB: POSTs
EDGE SERVER HIT: TRUE (sets request-type MATCH)
ORIGIN HIT: TRUE (sets request-type MATCH)
Sample Window: default T min (not display)
Excessive Burst Rate: B req/sec
Excessive Summary Rate: S req/sec
Automatic Penalty Box for Excessive Rates: default FALSE

With the above excessive rate categories declared, rate based controls for the firewall are available. Such rate-based controls allow a “penalty-box” rate qualification rule for each excessive rate category may be enabled and configured for ‘alert’ or ‘deny’, as explained previously with respect to FIG. 5.

In some embodiments, a portal user may specify an IP Whitelist that exempts given clients from being subject to the ‘alert’ or ‘deny’ action, e.g., because they are known good clients.

With the configuration defined via the portal, the metadata is generated and delivered to the CDN servers. For each rate category, a fragment of rate accounting metadata is inserted under the respective MATCH conditions (hostnames, URIs, VERBs, HIT-type, VARIABLE condition) the portal user had specified. If Automatic-Penalty-Box-for-Excessive-Rates is TRUE a metadata interface would be provided for handling the immediate promotion of offender to the penalty box.

In some embodiments, within the limited set of rate categories that a portal user is entitled to configure, there is a priority order. While all rate categories will be in effect and reported, limits may be imposed dynamically or statically within the runtime platform limiting either the memory available for categories or the reporting capacity of the categorized rate qualifications. Thus by setting priority, a portal user will be able to control this order (i.e. which category is the 0th and which is the nth).

More on CDN Server Workflow

This section provides additional details about the operation of a CDN server to provide rate accounting functionality. These operational details are meant to be illustrative and should not be construed as limiting.

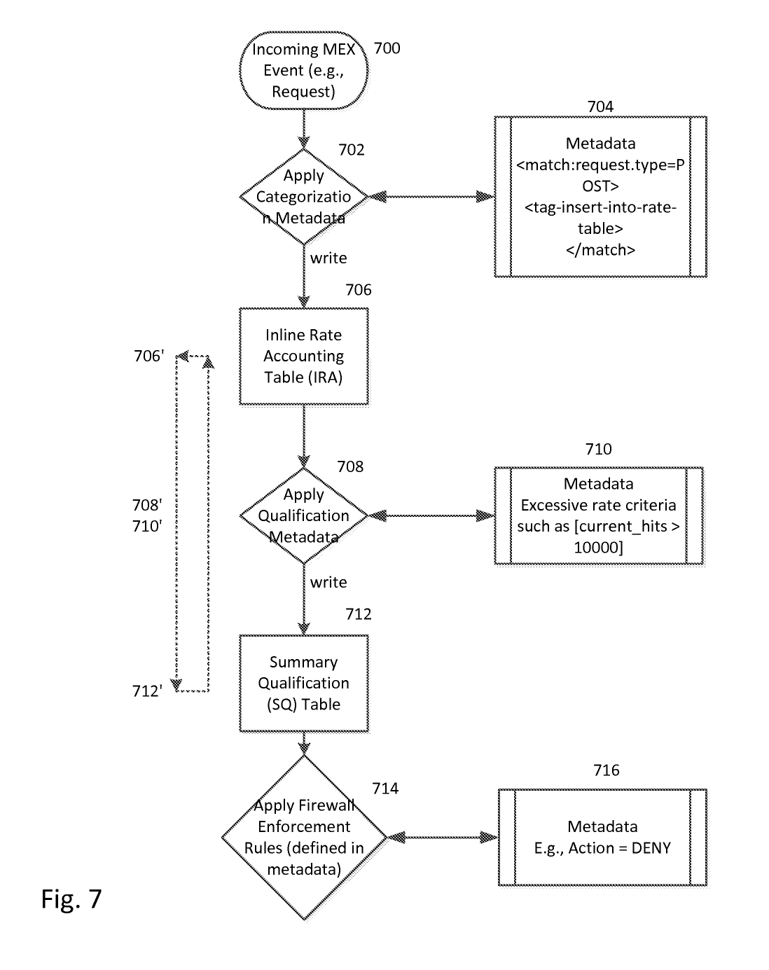

FIG. 7 illustrates two sub workflows. One relates to rate accounting and enforcement rules that can be applied to clients that have exceeded permissible rates. The second workflow is an event based (per-sampling period) workflow during which a sub-thread operates on the data collected in inline rate accounting (IRA) table and moves it to a summary qualification (SQ) table. This means that a client ID in the inline rate accounting table is placed in the summary qualification table, which effectively represents the “penalty box” described earlier with respect to FIG. 5. Details are as follows:

Rate Accounting WorkFlow:

In step 700, when a particular message exchange event occurs (e.g., received request from particular client, received response from origin server), metadata is applied to determine if triggers a particular message exchange category. (Step 702) For example, when a request from a particular client ID ‘x’ comes in, it can be matched against the metadata defining the category to determine if it meets the criteria and if so, in which table it should go and under which category it should fall. (For message exchanges dependent on later events, such as the content of a response from an origin server, the categorization determination would have to be finished when that event occurred in the later stage.) In FIG. 7, box 704 provides an example of metadata for a mex category that captures HTTP POST messages.

In steps 708 and 712, if a client request or other mex event pushes the rate over a configured threshold, when it arrives, it will get flagged as a burst offender (meaning it exceeded a certain rate during some burst time window, not necessarily the entire sampling period).

In step 713, firewall enforcement rules can read from the summary qualification table and apply defensive postures based on entries that are present in that table (steps 714, 716).

Periodic (Sampling Period) WorkFlow:

A thread runs at the end of each sampling period. This thread scans IRA tables for all content providers/domains and it applies the rate policy threshold criteria on each table, updates the SQ table and then cleans up the IRA table. This means that offending clients are placed in the SQ table. Subsequent incoming requests from such clients can be looked up in SQ table, and enforcement rules can fire based on that. This thread is represented by steps 706′-712′ in FIG. 7.

A thread will run periodically that will remove entries from the SQ table that have expired. This thread will go over all entries in the SQ table belonging to all content providers/domains.

In overview, metadata 704 controls the writing of rate accounting data into the IRA tables, metadata 710 specifies policies that determine how to read from the IRA tables to escalate clients (offenders) from the IRA tables to the SQ table, and metadata 716 specifies how to read from the SQ tables to apply enforcement against the offending clients.

Message Exchange Tables: IRA and SQ

Inline Rate Accounting (IRA) table: This table collects rate information in a given time window, the sampling period. An example of an IRA table is provided in the Table 1 presented earlier. Each unique client ID seen in the current period occupies a row in this table. Each category_hits column corresponds to the number of times a given client ID has been seen so far, on the CDN server, with some specific request properties as defined by the metadata. In order to store/evaluate accurate summary rate for each category, an entry time needs to be associated with each category in the IRA table. In order to calculate bursts within a given category in a burst window, the number of hits in the window is stored along with the window id.

Summary Qualification (SQ) Table: With every IRA table, a Summary Qualification (SQ) table is created implicitly by the CDN server. The CDN server copies summary information to this table every sampling period, the length of which is defined by user-configurable summary qualification metadata. There are summary criteria, which correspond to the rate policies 530 with rate thresholds, described above. Entries satisfying the summary criteria such as rate>[number]/second are copied to SQ table from IRA table at the end of the current sampling period. Summary qualification table has different levels (“qualification levels”). Example levels include (1) SUMMARY, (2) BURST, (3) TOP_N qualification levels. In the basic configuration, the CDN server treats all levels the same—that is, regardless of the level under which it is qualified, the qualified client is subject to the same penalty period. In some implementations, however, qualified clients could be treated/penalized differently depending on their qualification level.

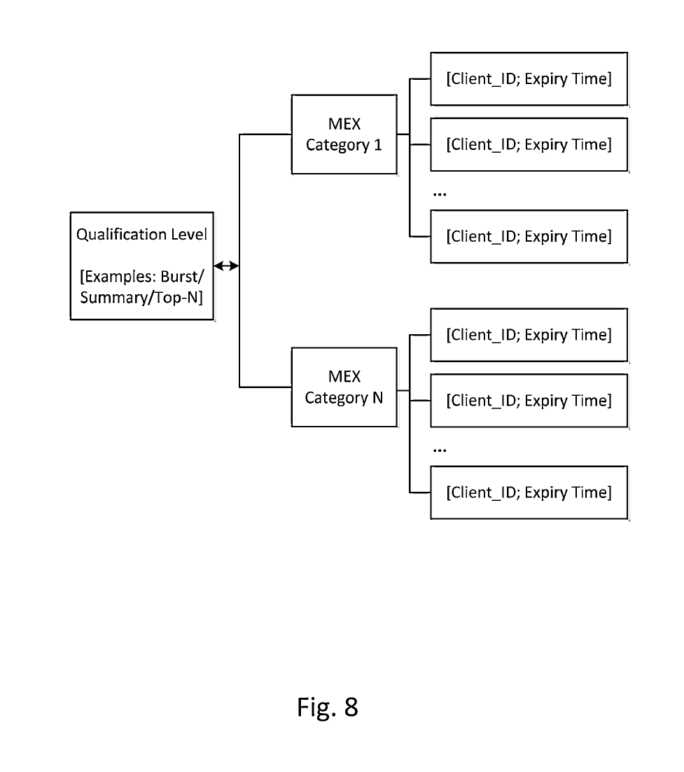

A schematic illustration of a summary qualification table is provided in FIG. 8. In FIG. 8, the client ID indicates which clients have been qualified within a given MEX category and at a given qualification level.

Rate Annotation

In a further embodiment, an origin server provides instructions to the CDN server about how to treat a particular message exchange. Typically the origin server provides such instructions as part of a response (e.g., in a header) to a forward request made by the CDN server. For example, for a given response, an origin server may indicate that the client is to be immediately qualified (a known bad actor), or that the IRA tables should be incremented by a specified amount (e.g., “add ten hits” to the table) which of course leads to quicker qualification for the client.

System Uses

The methods and systems described herein have many uses. By appropriately configuring message exchange categories and other aspects of the system, a content provider may be able to first, understand the nature of the traffic hitting their website, and second, take action against certain activities or actors causing that traffic.

For example, the portal through which the firewall is configured may also be arranged to report information about the traffic that is being collected. Charts showing traffic activity by time period, URI, client identity, and so on, provide insights into the traffic on the content provider's site.

Armed with this knowledge, a content provider may implement categories to target and limit activity on certain pages, such as product pages, login pages, news feeds, stock quotes, or other data feeds, or other areas where automated agents/content-scraping bots prove problematic. Similarly, attacks may be analyzed and/or mitigated by appropriate configuration of the system.

Another scenario involves detecting fraud in online contest voting or surveys. In this application, a message exchange category may be defined to capture vote requests (at a particular URI), coming from a particular geography as determined by a location service keyed off of source IP address. Too many votes from certain geographies may indicate an external attempt to influence voting.

Clients behind a proxy server or network address translation (NAT) device can pose a problem for rate-accounting at a CDN server (as well as at non-CDN servers). This is because the traffic from many clients behind the proxy or NAT may look like it is coming from one client, that is, from the IP address of the proxy server or NAT. The system described herein addresses this issue. First, as already noted, the system enables use of an identifier other than client IP address (e.g., session id, user id, cookies, etc., as noted above). In addition, the richness of the message exchange model allows for targeting of particular semantic behaviors on a site (via message exchange category definition) and/or targeting of traffic that is causing certain undesirable activity between the CDN server and the origin. This model allows for an analysis of traffic that is disassociated from transport and network layer identifiers such as IP address—or that is at least not necessarily associated with such identifiers. Hence, a client IP address may not necessarily be qualified merely because it is a NAT or proxy aggregating traffic from many clients behind it. But if some portion of that traffic is behaving “badly” (as defined by the content provider via mex categories) then the system may qualify and defend against that traffic. In sum, the system may be configured to ignore the “false positive” of a large proxy behind which are numerous “good” clients, while also enabling the detection of “bad” clients “hiding” behind proxies or analogous devices.

It should be understood that the foregoing discussion is illustrative only, merely offering potential uses and advantages of the teachings herein. It should not be viewed as limiting, nor should any particular use or advantage be viewed as necessary to the practice of the invention.

Centralized Threat Assessment

In a further embodiment, the rate accounting information gathered by each CDN server is reported back to central data collection and control system, such as system 108 shown in FIG. 1, as modified by the teachings herein. Preferably, the information is reported to the back-end system 108 using a dedicated fast communication channel. U.S. Pat. No. 7,149,807 describes a suitable control and communication infrastructure (CCI) for this purpose, and the contents of that patent are hereby incorporated by reference.

The central data collection and control system 108 can use this reported information to identify network-level threats and to push instructions to CDN servers to configure them to deal with the threat, e.g., by applying particular enforcement policies or otherwise. In many cases, the central controller may be able to proactively configure CDN servers that have not yet encountered the threat.

Despite the central data collection and control system 108, the individual CDN servers may in some cases continue to make their own qualification and enforcement policy decisions, as described previously. For example, the CDN servers 102 in FIG. 1 can report information from or related to the summary qualification (SQ) table to the server(s) in the system 108. This information may include a time (time stamp or epoch), a firewall identifier (identifying the firewall associated with the content provider to which the data applies), a mex category identifier, and a client identifier, and a qualification level. Note that each qualified client is associated with a qualification level which is indicative of the reason it was qualified (burst offender, etc.) as described above. In sum, the CDN servers 102 can report back to system 108 with information that identifies the qualified clients they are seeing, according to the message exchange category definitions provided by the content providers.

In other cases, the CDN servers 102 may send the underlying data from their IRA tables to the central server(s). The IRA tables contain data filtered by content-provider defined message exchange categories. This information can then be used for analysis and to alert other CDN servers 102 across the network. Note that the CDN service provider may also define “system-wide” message exchange categories that represent categories of interest to the entire system. This information can be used to counter threats to the security and stability of the overall platform.

The system 108 evaluates the information sent from the CDN servers (whether it be qualification decisions and/or underlying data and/or otherwise) in order to make a decision about enforcement policy. Put another way, the system 108 evaluates the information to determine the severity and nature of a particular client's actions. Factors in this determination may include the request rate for the client, prior history of the client, location of the client or CDN server 102, whether the given client is being qualified at multiple POPs 107, etc. A content provider may provide configuration information that drives this determination. In some cases, the decision may be automatic and unconditional—that is, the existence of a qualified client at a given CDN server 102 automatically triggers the system to initiate notification to others CDN servers 102, of a particular subset thereof, without further conditions. In addition, attack scenario intelligence may drive the decision. For example, the fact that a particular client has been flagged by multiple CDN servers 108 may indicate the beginning of a bot-net attack against a particular content provider. The attack may be spreading geographically across the network.

Based on its analysis, the system 108 may take a variety of actions. It may instruct the CDN server 102 that reported the information to apply an enforcement policy, if that CDN server 102 has not done so already. This might occur because the system 108 is seeing an excessive global rate while rate at the individual CDN server 102 is too low to warrant a response. Alternatively, the system 108 may instruct CDN servers 102 that have not yet encountered the threat to pro-actively apply an enforcement policy against the client. This may take the form of a network-wide or global instruction to all CDN servers 102, or to a subset thereof (e.g., other CDN servers 102 residing in the same or nearby POPs 107). Furthermore, the system 108 may instruct the CDN servers 102 to send additional information (i.e., changing the threshold levels for the message exchanges so that more or less data is seen, or altering the message exchange category definitions) so the system can intake additional intelligence and gain a more accurate picture of the threat.

While the instructions sent from the system 108 to the CDN servers 102 may take many forms, in one implementation the system 108 sends a configuration update that causes the CDN server 102 to insert a record into its SQ table, which causes the firewall to treat that particular client as a qualified client (even if they have not yet encountered the client). The system 108 also tells the CDN servers 102 what qualification level to use for that particular client. As mentioned previously, the qualification level typically indicates whether the client was qualified as a level 1 (Summary), 2 (Burst), or 3 (Top-N) offender. However, other qualification levels are possible, each with their own significance to the CDN server 102 in terms of how to handle that particular client. Hence, system 108 instruct the CDN servers 102 that the qualified client should be qualified as a level [N] offender, which is associated with a certain course of action. Level [N] may be associated with enhanced penalties, such as a permanent ban until subsequent configuration push from the system 108, or merely enhanced monitoring.

While the foregoing has focused on qualified clients as an example, it should be understood that the network threat assessment system applies equally to other models for the system—that is, the system may perform network level threat assessment and proactive qualification for qualified URIs, as previously described.

Computer Based Implementation

The clients, servers, and other devices described herein may be implemented with conventional computer systems, as modified by the teachings hereof, with the functional characteristics described above realized in special-purpose hardware, general-purpose hardware configured by software stored therein for special purposes, or a combination thereof.

Software may include one or several discrete programs. Any given function may comprise part of any given module, process, execution thread, or other such programming construct. Generalizing, each function described above may be implemented as computer code, namely, as a set of computer instructions, executable in one or more processors to provide a special purpose machine. The code may be executed using conventional apparatus—such as a processor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

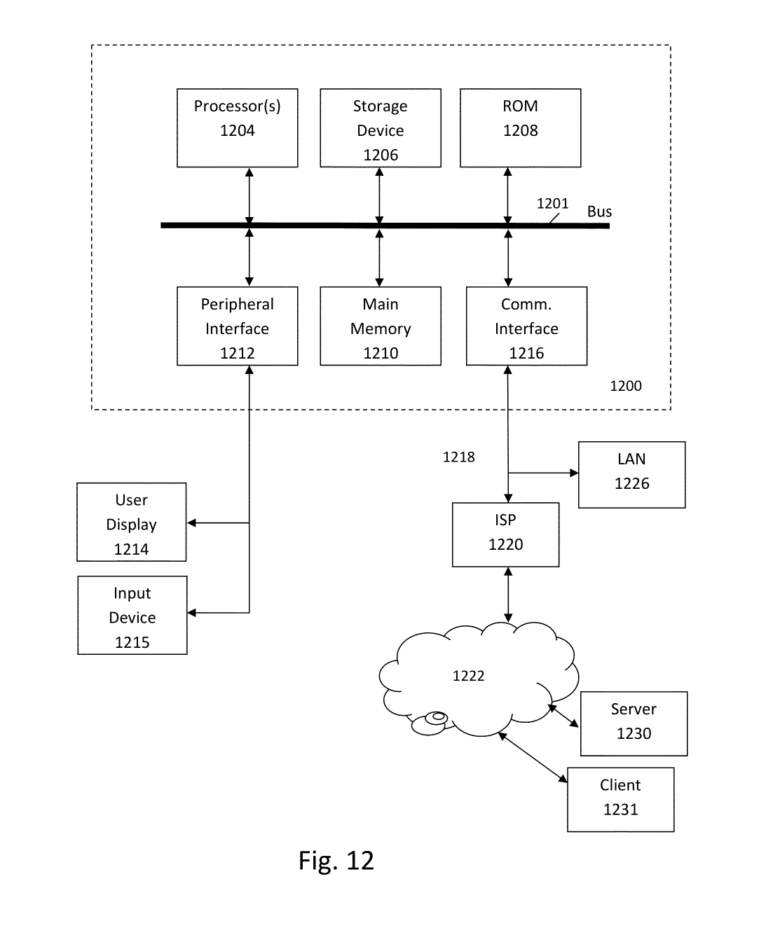

FIG. 12 is a block diagram that illustrates hardware in a computer system 1200 upon which such software may run in order to implement embodiments of the invention. The computer system 1200 may be embodied in a client device, server, personal computer, workstation, tablet computer, wireless device, mobile device, network device, router, hub, gateway, or other device. Representative machines on which the subject matter herein is provided may be Intel Pentium-based computers running a Linux or Linux-variant operating system and one or more applications to carry out the described functionality.

Computer system 1200 includes a processor 1204 coupled to bus 1201. In some systems, multiple processor and/or processor cores may be employed. Computer system 1200 further includes a main memory 1210, such as a random access memory (RAM) or other storage device, coupled to the bus 1201 for storing information and instructions to be executed by processor 1204. A read only memory (ROM) 1208 is coupled to the bus 1201 for storing information and instructions for processor 1204. A non-volatile storage device 1206, such as a magnetic disk, solid state memory (e.g., flash memory), or optical disk, is provided and coupled to bus 1201 for storing information and instructions. Other application-specific integrated circuits (ASICs), field programmable gate arrays (FPGAs) or circuitry may be included in the computer system 1200 to perform functions described herein.

A peripheral interface 1212 communicatively couples computer system 1200 to a user display 1214 that displays the output of software executing on the computer system, and an input device 1215 (e.g., a keyboard, mouse, trackpad, touchscreen) that communicates user input and instructions to the computer system 1200. The peripheral interface 1212 may include interface circuitry, control and/or level-shifting logic for local buses such as RS-485, Universal Serial Bus (USB), IEEE 1394, or other communication links.

Computer system 1200 is coupled to a communication interface 1216 that provides a link (e.g., at a physical layer, data link layer, or otherwise) between the system bus 1201 and an external communication link. The communication interface 1216 provides a network link 1218. The communication interface 1216 may represent a Ethernet or other network interface card (NIC), a wireless interface, modem, an optical interface, or other kind of input/output interface.

Network link 1218 provides data communication through one or more networks to other devices. Such devices include other computer systems that are part of a local area network (LAN) 1226. Furthermore, the network link 1218 provides a link, via an internet service provider (ISP) 1220, to the Internet 1222. In turn, the Internet 1222 may provide a link to other computing systems such as a remote server 1230 and/or a remote client 1231. Network link 1218 and such networks may transmit data using packet-switched, circuit-switched, or other data-transmission approaches.

In operation, the computer system 1200 may implement the functionality described herein as a result of the processor executing code. Such code may be read from or stored on a non-transitory computer-readable medium, such as memory 1210, ROM 1208, or storage device 1206. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 1218 (e.g., following storage in an interface buffer, local memory, or other circuitry).

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

1.-11. (canceled)

12. A computer-implemented method operative at a proxy server that comprises circuitry forming one or more processors and memory holding instructions for execution by the one or more processors, the proxy server being communicatively coupled to a computer network, the method comprising:
at the proxy server, participating in an exchange of messages between at least one of (i) a client and the proxy server and (ii) the proxy server and an origin server, wherein the exchange of messages is in accordance with a protocol and includes at least one request message and at least one response message;
applying one or more match conditions against the content of multiple messages in the exchange of messages, the one or more match conditions defining a category of message traffic that is of interest;
if the one or more match conditions are satisfied, recording information about the message exchange at the proxy server; and,
if the one or more match conditions are not satisfied, not recording said information.

13. The method of claim 12, wherein the multiple messages in the exchange of messages include at least one response message received by the proxy server from the origin server.

14. The method of claim 12, wherein the multiple messages in the exchange of messages include at least one request message sent from the proxy server to the origin server.

15. The method of claim 12, wherein the one or more match conditions include a condition that is satisfied by any request message from the proxy server to the origin server.

16. The method of claim 12, wherein the multiple messages in the exchange of messages include at least one request message and at least one response message.

17. The method of claim 12, wherein messages have headers and bodies and the one or more match conditions specify a matching value for a field in any of a message header and a message body.

18. The method of claim 12, wherein the protocol comprises HTTP and the one or more match conditions specify a matching value for an HTTP method.

19. The method of claim 12, wherein recording information comprises incrementing a count associated with the category of traffic described by the one or more match conditions.

20. The method of claim 12, wherein recording information comprises incrementing a count for a client identifier associated with the client.

21. The method of claim 12, wherein recording information comprises incrementing a count associated with a URI related to the exchange of messages.

22. The method of claim 12, wherein recording information comprises incrementing a count associated with the category of message traffic defined by the one or more match conditions, and further comprising:
using the recorded information to calculate a rate of occurrence for message traffic falling within the category that is associated with a particular client or URI.

23. The method of claim 12, wherein recording information comprises incrementing a count associated with the category of message traffic defined by the one or more match conditions, and further comprising:
using the recorded information to calculate a rate of occurrence for message traffic that falls within the category and that is associated with a particular client or URI, and,
comparing the rate of occurrence to a threshold value to determine whether to limit requests associated with the particular client or URI.

24. The method of claim 12, wherein the protocol is HTTP.

25. A proxy server, comprising:
circuitry forming one or more processors;
a hardware interface communicatively coupled to a computer network;
memory holding instructions for execution by the one or more processors, wherein the instructions, when executed by the one or more processors, cause the proxy server to:
participate in an exchange of messages between at least one of (i) a client and the proxy server and (ii) the proxy server and an origin server, wherein the exchange of messages is in accordance with a protocol and includes at least one request message and at least one response message;
apply one or more match conditions against the content of multiple messages in the exchange of messages, the one or more match conditions defining a category of message traffic that is of interest;
if the one or more match conditions are satisfied, record information about the message exchange at the proxy server; and,
if the one or more match conditions are not satisfied, not record said information.

26. The proxy server of claim 25, wherein the multiple messages in the exchange of messages include at least one response message received by the proxy server from the origin server.

27. The proxy server of claim 25, wherein the multiple messages in the exchange of messages include at least one request message sent from the proxy server to the origin server.

28. The proxy server of claim 25, wherein the one or more match conditions include a condition that is satisfied by any request message from the proxy server to the origin server.

29. The proxy server of claim 25, wherein the multiple messages include at least one request message and at least one response message.

30. The proxy server of claim 25, wherein messages have headers and bodies and the one or more match conditions specify a matching value for a field in any of a message header and a message body.

31. The proxy server of claim 25, wherein the protocol comprises HTTP and the one or more match conditions specify a matching value for an HTTP method.

32. The proxy server of claim 25, wherein the proxy server records information by incrementing a count associated with the category of message traffic described by the one or more match conditions.

33. The proxy server of claim 25, wherein the proxy server records information by incrementing a count for a client identifier associated with the client.

34. The proxy server of claim 25, wherein the proxy server records information by incrementing a count associated with a URI related to the exchange of messages.

35. The proxy server of claim 25, wherein the proxy server records information by incrementing a count associated with the category of message traffic defining by the one or more match conditions, and the proxy server further:
uses the recorded information to calculate a rate of occurrence for message traffic that falls within the category and that is associated with a particular client or URI.

36. The proxy server of claim 25, wherein recording information comprises incrementing a count associated with the category of message traffic defined by the one or more match conditions, and the proxy server further:
uses the recorded information to calculate a rate of occurrence for message traffic falling within the category that is associated with a particular client or URI, and,
compares the rate of occurrence to a threshold value to determine whether to limit requests associated with the particular client or URI.

37. The proxy server of claim 25, wherein the protocol is HTTP.

38.-88. (canceled)
